(19) United States
(12) Patent Application Publication
(10) Pub. No.: US 2004/0032560 A1
(43) Pub. Date: Feb. 19, 2004

(54) Liquid crystal device, liquid-crystal-device production method, and electronic device

(75) Inventor: Takehito Washizawa, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/462,842

(22) Filed: Jun. 17, 2003

(30) Foreign Application Priority Data
Jul. 10, 2002 (JP) 2002-201247

(51) Int. Cl. G02F 1/1339

(52) U.S. Cl. 349/155

(57) ABSTRACT

The invention provides a liquid crystal device in which the cell gap can be made uniform in substrate planes and degradation of display characteristics, such as contrast reduction, is reduced or hardly occurs. A liquid crystal device of the present invention has a configuration in which spacers are placed between a lower substrate and an upper substrate that hold a liquid crystal layer therebetween. The liquid crystal layer and the spacers are placed inside a sealing material shaped like a closed frame in the substrate planes, and the density of the spacers inside the sealing material is set at 50 to 150 spacers per square millimeter.

### BACKGROUND OF THE INVENTION

1. Field of Invention

The present invention relates to a liquid crystal device, a production method for the liquid crystal device, and an electronic device incorporating the liquid crystal device. More particularly, the present invention relates to a technique of arranging spacers between substrates.

2. Description of Related Art

A related art liquid crystal device includes a lower substrate and an upper substrate that are bonded at their peripheral edges by a sealing material, and a liquid crystal layer that is sealed between the pair of substrates. In this case, spacers are arranged between the pair of substrates in order to ensure a uniform cell gap in the substrate planes.

Such a liquid crystal device is produced by the following method. That is, after electrodes, an alignment film, and so on are stacked on each of a lower substrate and an upper substrate, for example, an uncured sealing material is printed on the lower substrate while a liquid-crystal injection port is formed at the peripheral edge of the substrate, spacers are dispersed on the surface of the same substrate or the other substrate, and the lower substrate and the upper substrate are bonded with the uncured sealing material therebetween, thereby obtaining a liquid crystal cell. Then, the uncured sealing material of the liquid crystal cell is cured, and liquid crystal is injected into the liquid crystal cell through the preformed liquid-crystal injection port to form a liquid crystal layer. Subsequently, the injection port is sealed with a sealing member. Finally, optical elements, such as a retardation film and a polarizing plate, are formed outside the lower substrate and the upper substrate, and a liquid crystal device having the above configuration is produced.

### SUMMARY OF THE INVENTION

In this case, since substrate bonding is performed before liquid crystal is injected, only the spacers receive the pressure during substrate bonding. In order to stand the bonding pressure, the number of spacers cannot be reduced. More specifically, the necessary number is, for example, approximately 200 to 300 per square millimeter. When the number of spacers is small, there is little influence on the display, high-contrast display is possible, and the cost can be reduced. However, in the above production method, the limit of the number is approximately 200 per square millimeter in order to ensure a uniform cell gap (thickness of the liquid crystal layer).

The present invention addresses the above and/or other problems, and provides a liquid crystal device in which the cell gap can be made uniform in substrate planes and degradation of display characteristics, such as contrast reduction, is reduced or hardly occurs. The invention also provides a production method for the liquid crystal device and an electronic device having the liquid crystal device.

In order to address or overcome the above, the present invention provides a liquid crystal device that includes spacers placed between a pair of substrates that hold a liquid crystal layer therebetween. The liquid crystal layer and the spacers are placed inside a sealing material shaped like a closed frame in planes of the substrates. The density of the spacers inside the sealing material is 50 to 150 spacers per square millimeter.

In the liquid crystal device of the present invention, since the sealing material is shaped like a closed frame in the planes of the substrates, liquid crystal cannot be injected after substrate bonding during production of the liquid crystal device, and the substrates must be bonded after dropping liquid crystal on one of the substrates. In this case, since the substrates can be bonded in a state in which liquid crystal is dropped and spacers are dispersed on the substrate, not only the spacers, but only the liquid crystal receive the pressure during substrate bonding, and the number of spacers can be made smaller than that in the related art liquid crystal device having an injection port. That is, since the liquid crystal serves to receive a part of the bonding pressure, even when the number of spacers is reduced, it is possible to stand the bonding pressure and to ensure a uniform cell gap.

Therefore, since the sealing material is shaped like a closed frame in the substrate planes in the present invention, the density of the spacers inside the frame of the sealing material can be reduced to 50 to 150 spacers per square millimeter. Consequently, the influence of the spacers on the display is made less than before, and the contrast reduction is hardly caused by light leakage adjacent to the spacers. As a result, it is possible to provide the liquid crystal device having the above features that can reduce the number of spacers to be used to reduce the cost and to enhance the display characteristics.

When the dispersion density of the spacers is lower than 50 spacers per square millimeter, it is sometimes difficult to ensure a uniform thickness of the liquid crystal layer (cell gap) in the substrate planes, and this reduces the display quality. When the dispersion density of the spacers exceeds 150 spacers per square millimeter, the degree of cost reduction is sometimes reduced, light leakage is prone to occur, and the degree of enhancement of the contrast is reduced.

If liquid crystal is injected before substrate bonding while using a sealing material having an injection port as before, trouble, such as leakage of liquid crystal, occurs during substrate bonding. Therefore, it is practically impossible to inject liquid crystal before substrate bonding when the sealing material having an injection port is formed. In contrast, of course, liquid crystal cannot be injected after substrate bonding when the sealing material of the present invention that does not have an injection port is used. Therefore, the features of the present invention make it possible to reliably inject liquid crystal before substrate bonding and to achieve a spacer dispersion density within the above range.

In the liquid crystal device of the present invention, specifically, the sealing material may be shaped like a frame without projecting from the outer edges of the substrates. More specifically, the sealing material may be shaped like a closed frame that does not have an opening pointing toward the outer edges of the substrates. By thus shaping the sealing material like a frame that does not have a liquid-crystal injection port and that is completely closed (specifically, a closed frame), a production method in which liquid crystal is dropped on the substrate before substrate bonding and the substrates are bonded after the spacers are dispersed on one of the substrates can be adopted. Therefore, the dispersion density of the spacers can be reduced to 50 to 150 spacers per square millimeter, as described above.

In the liquid crystal device of the present invention, the surface of each of the spacers is partially or entirely provided with an alignment regulating device. While the orientation of the liquid crystal is sometimes disturbed adjacent to the surface of the spacer and the contrast is reduced, the liquid crystal can be aligned adjacent to the surface of the spacer by thus providing the alignment regulating device on the surface of the spacer. Therefore, it is possible to provide a liquid crystal device in which light leakage is reduced or prevented and in which trouble, such as contrast reduction, rarely occurs.

As the alignment regulating means, for example, a long-chain alkyl group may be added to the surface of the spacer by using a silane coupling agent.

The surface of the spacer may be partially or entirely covered with a cured thermosetting resin. By thus forming the thermosetting resin on the surface of the spacer and, for example, subjecting the thermosetting resin to heat treatment after the spacer is placed at a predetermined position between the substrates, the spacer can be stably fixed to the substrates, and trouble, such as floating and displacement of the spacer from the predetermined position, can be reduced or prevented.

The spacer may be colored. For example, when the liquid crystal device is used as a display device, light sometimes passes through a spacer and white display (bright display) is performed at that portion in a region where black display (dark display) should be performed. By coloring the spacer, as described above, particularly, by using a spacer colored in black, black display (dark display) can be performed reliably.

A production method for the above liquid crystal device includes the following steps. That is, a liquid-crystal-device production method of the present invention includes: dropping liquid crystal on one of a pair of substrates, forming a sealing material shaped like a closed frame in the plane of one of the pair of substrates, dispersing spacers on one of the pair of substrates, and bonding the pair of substrates. The dispersion density of the spacers is set at 50 to 150 spacers per square millimeter inside the frame of the sealing member.

In the liquid-crystal-device production method of the present invention, liquid crystal is dropped on a substrate before substrate bonding, a sealing material is formed on the substrate or a different substrate, spacers are dispersed on one of the substrates, and the pair of substrates are then bonded together. Since not only the spacers, but also the liquid crystal layer receives the pressure during substrate bonding, even when the density of the spacers is decreased, the cell gap in the substrate planes will not become nonuniform. That is, by performing the above steps and setting the dispersion density of the spacers within the above range, a liquid crystal device can be provided in which in-plane uniformity of the cell gap is ensured and, for example, contrast reduction is rarely caused by light leakage due to the influence of the spacers.

A production method for the liquid crystal device of the present invention may include the following. That is, another liquid-crystal-device production method of the present invention includes: forming a sealing material on one of a pair of substrates, the sealing material being shaped like a closed frame in the plane of the substrate, dropping liquid crystal inside the sealing material, dispersing spacers on one of the pair of substrates, and bonding the pair of substrates together. The dispersion density of the spacers is set at 50 to 150 spacers per square millimeter inside the frame of the sealing material.

In such a production method, liquid crystal is dropped on a substrate, on which a frame-shaped sealing material is formed, and inside the frame of the sealing material before substrate bonding, spacers are dispersed on one of the substrates, and the pair of substrates are then bonded together. Therefore, not only the spacers, but also the liquid crystal layer receives the pressure during substrate bonding. Consequently, even when the density of the spacers is decreased, the cell gap in the substrate planes will not become non-uniform. That is, by performing the above steps and setting the dispersion density of the spacers within the above range, a liquid crystal device can be provided in which in-plane uniformity of the cell gap is ensured, and for example, contrast reduction is rarely caused by light leakage due to the influence of the spacers.

An electronic device of the present invention has the above liquid crystal device as a display device. By using the liquid crystal device of the present invention in this way, an electronic device of high display quality can be provided.

### BRIEF DESCRIPTION OF THE DRAWINGS

FIG. 1 is a schematic showing switching elements, signal lines, and so on in a liquid crystal device according to a first exemplary embodiment of the present invention;

FIG. 2 is a plan view showing a plurality of adjoining pixels on a TFT array substrate in the liquid crystal device shown in FIG. 1;

FIG. 3 is a cross-sectional view showing a non-display region of the liquid crystal device shown in FIG. 1;

FIG. 4 is a schematic plan view roughly showing the overall configuration of the liquid crystal device shown in FIG. 1;

FIG. 5 is a cross-sectional view showing a display region of the liquid crystal device shown in FIG. 1;

FIG. 6 is a schematic showing the structure of a spacer;

FIG. 7 is a schematic showing the structure of a spacer provided with a surface-treated layer;

FIG. 8 is a schematic showing the structure of a colored spacer;

FIGS. 9A and 9B are schematics showing an advantage provided by using the spacer shown in FIG. 7;

FIGS. 10A and 10B are schematics showing an advantage provided by using the spacer shown in FIG. 8;

FIG. 11 is a flowchart showing a production method for the liquid crystal device shown in FIG. 1;

FIG. 12 is a flowchart showing another production method for the liquid crystal device shown in FIG. 1;

FIGS. 13A to 13C are perspective views showing some examples of electronic devices according to the present invention.

### DETAILED DESCRIPTION OF PREFERRED EMBODIMENTS

An exemplary embodiment of the present invention is described below with reference to the drawings.

[Liquid Crystal Device]

The following liquid crystal device of this exemplary embodiment is an active-matrix transmissive liquid crystal device using TFTs (Thin Film Transistors) as switching elements. The liquid crystal device of this exemplary embodiment includes spacers arranged between a pair of substrates that hold a liquid crystal layer therebetween, and a sealing material that bonds the pair of substrates and that seals the liquid crystal layer inside the pair of substrates.

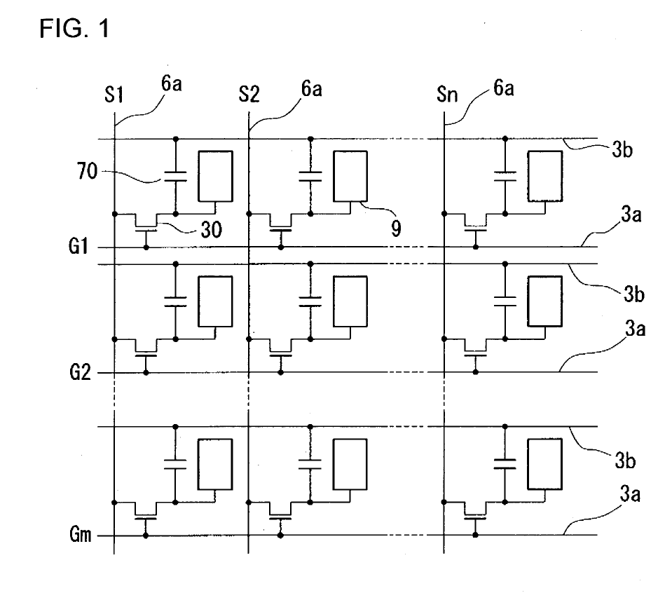

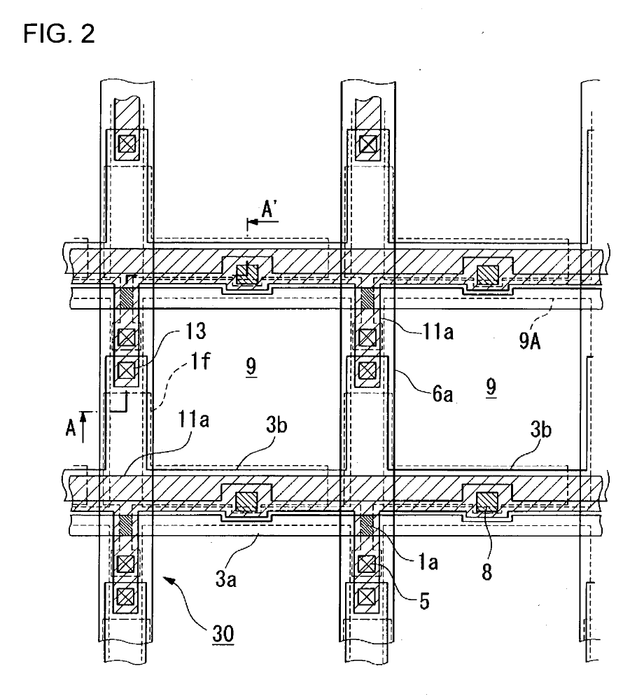

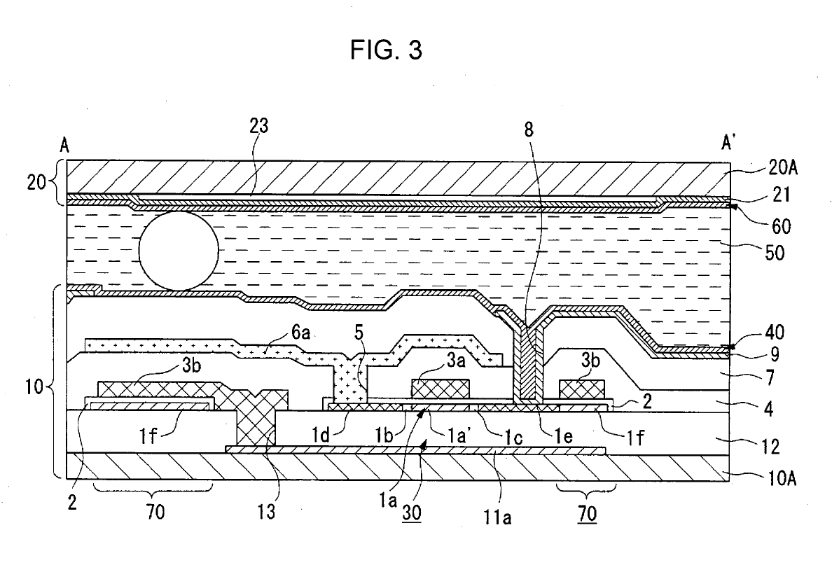

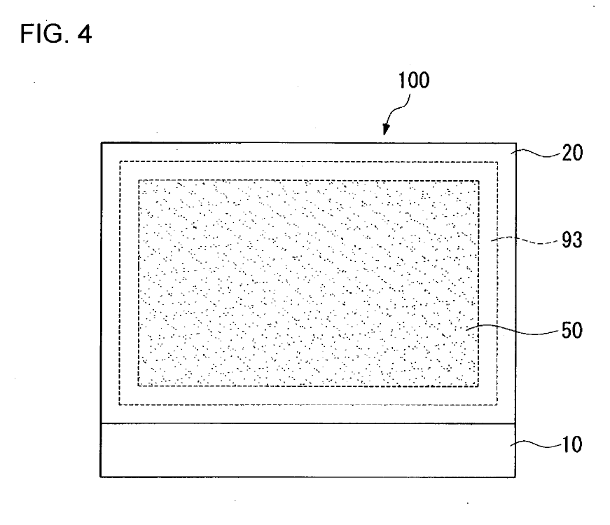

FIG. 1 is a schematic showing switching elements, signals lines, and so on in a plurality of pixels arranged in a matrix in the transmissive liquid crystal device of this exemplary embodiment. FIG. 2 is a principal plan view showing the configurations of a plurality of adjoining pixels of a TFT array substrate on which data lines, scanning lines, pixel electrodes, and so on are formed. FIG. 3 is a cross-sectional view, taken along plane A-A′ in FIG. 2, and FIG. 4 is a general plan view showing the overall planar configuration of the transmissive liquid crystal device of this exemplary embodiment. The upper side of FIG. 3 is a light incident side, and the lower side is a viewing side (observer side). In these figures, layers and members are shown on different scales to make them more easily recognizable in the figures.

In the transmissive liquid crystal device of this exemplary embodiment, as shown in FIG. 1, each of a plurality of pixels arranged in a matrix includes a pixel electrode 9, and a TFT element 30 serving as a switching element to control the current application to the pixel electrode 9. A data line 6a through which an image signal is supplied is electrically connected to a source of the TFT element 30. Image signals S1, S2, . . . , Sn to be written in the data lines 6a are line-sequentially supplied in that order, or are supplied in groups to a plurality of adjoining data lines 6a.

A scanning line 3a is electrically connected to a gate of the TFT element 30. Scanning signals G1, G2, . . . , Gm are line-sequentially applied to a plurality of scanning lines 3a at a predetermined timing and in a pulse form. The pixel electrode 9 is electrically connected to a drain of the TFT element 30. By activating the TFT elements 30 serving as switching elements only for a given period, the image signals S1, S2, . . . , Sn supplied through the data lines 6a are written at a predetermined timing.

The image signals S1, S2, . . . , Sn with a predetermined level written in liquid crystal through the corresponding pixel electrodes 9 are held for a given period between the pixel electrodes 9 and a common electrode described below. The alignment and order of molecules of the liquid crystal are changed in accordance with the level of an applied voltage to modulate light and to permit half-tone display. In order to prevent the held image signals from leaking or to reduce such leakage, storage capacitors 70 are added in parallel with liquid crystal capacitors formed between the pixel electrodes 9 and the common electrode.

Next, a description is provided of the planar configuration of the principal part of the transmissive liquid crystal device of this exemplary embodiment with reference to FIG. 2. As shown in FIG. 2, a plurality of rectangular pixel electrodes 9 (their outlines are shown by dotted portions 9A) made of a transparent conductive material, such as indium tin oxide (hereinafter “ITO”), are provided in a matrix on a TFT array substrate, and data lines 6a, scanning lines 3a, and capacitor lines 3b are provided along the lengthwise and breadthwise boundaries of the pixel electrodes 9a. In this exemplary embodiment, a region in which each pixel electrode 9, and data lines 6a, scanning lines 3a, capacitor lines 3b, and so on that surround the pixel electrode 9 are formed serves as a pixel, and display can be performed in each of the pixels arranged in a matrix.

Each data line 6a is electrically connected to a below-described source region of a semiconductor layer 1a, which forms the TFT element 30 and is made of, for example, a polysilicon film, through a contact hole 5, and each pixel electrode 9 is electrically connected to a below-described drain region of the semiconductor layer 1a through a contact hole 8. Each scanning line 3a is placed to oppose a below-described channel region (region shaded by downward-slanting lines in the figure) of the semiconductor layer 1a. A portion of the scanning line 3a opposing the channel region functions as a gate electrode.

Each capacitor line 3b includes a main portion extending in a substantially linear manner along the scanning line 3a (that is, a first portion formed along the scanning line 3a in plan view), and a projecting portion projecting from an intersection with the data line 6a toward the upstream side (upper side in the figure) along the data line 6a (that is, a second portion extending along the data line 6a in plan view).

In FIG. 2, a plurality of first shielding films 11a are provided in regions shown by upward-slanting lines.

The sectional configuration of the transmissive liquid crystal device of this exemplary embodiment is described below with reference to FIG. 3. As described above, FIG. 3 is a cross-sectional view taken along plane A-A′ in FIG. 2, and a cross-sectional view showing the configuration of a region in which the TFT element 30 is formed. In the transmissive liquid crystal device of this exemplary embodiment, a liquid crystal layer 50 is held between a TFT array substrate 10, and a counter substrate 20 placed opposed thereto.

The liquid crystal layer 50 is made of smectic liquid crystal that is ferroelectric liquid crystal, and makes a fast driving response to changes in voltage. The TFT array substrate 10 mainly includes a substrate body 10A made of a transmissive material, such as quartz, and TFT elements 30, pixel electrodes 9, and an alignment film 40 formed on a surface of the substrate body 10A close to the liquid crystal layer 50. The counter substrate 20 mainly includes a substrate body 20A made of a transmissive material, such as glass or quartz, and a common electrode 21 and an alignment film 60 formed on a surface of the counter substrate 20 close to the liquid crystal layer 50. A predetermined gap is maintained between the substrates 10 and 20 with spacers 15 therebetween.

In the TFT array substrate 10, the pixel electrodes 9 are provided on the surface of the substrate body 10A close to the liquid crystal layer 50. A pixel-switching TFT element 30 to control the switching of each pixel electrode 9 is provided adjacent to the pixel electrode 9. The pixel-switching TFT element 30 has an LDD (Lightly Doped Drain) structure, and includes a scanning line 3a, a channel region 1a′ of a semiconductor layer 1a in which a channel is formed by an electric field from the scanning line 3a, a gate insulating film 2 for insulating the scanning line 3a and the semiconductor layer 1a, a data line 6a, a lightly-doped source region 1b and a lightly-doped drain region 1c of the semiconductor layer 1a, and a heavily-doped source region 1d and a heavily-doped drain region 1e of the semiconductor layer 1a.

A second interlayer insulating film 4 having a contact hole 5 communicating with the heavily-doped source region 1d and a contact hole 8 communicating with the heavily-doped drain region 1e is formed on the substrate body 10A including the scanning line 3a and the gate insulating film 2. That is, the data line 6a is electrically connected to the heavily-doped source region 1d through the contact hole 5 formed through the second interlayer insulating film 4.

Furthermore, a third interlayer insulating film 7 having a contact hole 8 communicating with the heavily-doped drain region 1e is formed on the data line 6a and the second interlayer insulating film 4.

That is, the heavily-doped drain region 1e is electrically connected to the pixel electrode 9 through the contact hole 8 formed through the second interlayer insulating film 4 and the third interlayer insulating film 7.

In this exemplary embodiment, the gate insulating film 2 extends from a position opposing the scanning line 3a to be used as a dielectric film, the semiconductor film 1a extends to serve as a first storage-capacitor electrode 1f, and a part of the capacitor line 3b opposing them serves as a second storage-capacitor electrode, thereby constituting a storage capacitor 70.

A first shielding film 11a is provided in a region, in which each pixel-switching TFT element 30 is formed, on the surface of the substrate body 10A of the TFT array substrate 10 close to the liquid crystal layer 50. The first shielding film 11a reduces or prevents return light, which is transmitted through the TFT array substrate 10, is reflected by the lower surface of the TFT array substrate 10 in the figure (an interface between the TFT array substrate 10 and air), and returns toward the liquid crystal layer 50, from entering at least the channel region 1a′ and the lightly-doped source and drain regions 1b and 1c of the semiconductor layer 1a.

A first interlayer insulating film 12 for electrically insulating the semiconductor layer 1a that forms the pixel-switching TFT element 30 from the first shielding film 11a is formed between the first shielding film 11a and the pixel-switching TFT element 30. As shown in FIG. 2, the first shielding film 11a is provided on the TFT array substrate 10, and is electrically connected to the upstream or downstream capacitor line 3b through a contact hole 13.

An alignment film 40 to control the orientation of liquid crystal molecules in the liquid crystal layer 50 when a voltage is not applied is formed on the surface of the TFT array substrate 10 closest to the liquid crystal layer 50, that is, on the pixel electrode 9 and the third interlayer insulating film 7. Therefore, in such a region having the TFT element 30, a plurality of irregularities or steps are formed on the surface of the TFT array substrate 10 closest to the liquid crystal layer 50, that is, on a surface on which the liquid crystal layer 50 is held.

On the other hand, a second shielding film 23 is formed on the surface of the substrate body 20A of the counter substrate 20 close to the liquid crystal layer 50 and in a region opposing the data line 6a, the scanning line 3a, and the pixel-switching TFT element 30, that is, in a region outside of an aperture region of the pixel. The second shielding film 23 reduces or prevents incident light from entering the channel region 1a′, the lightly-doped source region 1b, and the lightly-doped drain region 1c of the semiconductor layer 1a of the pixel-switching TFT element 30. Furthermore, a common electrode 21 made of ITO or the like is formed almost on the entire surface of the substrate body 20A having the second shielding film 23 close to the liquid crystal layer 50. An alignment film 60 is formed on the side of the common electrode 21 close to the liquid crystal layer 50 to control the orientation of liquid crystal molecules in the liquid crystal layer 50 when a voltage is not applied.

FIG. 4 is a schematic plan view roughly showing the overall configuration of a transmissive liquid crystal device 100 of this exemplary embodiment. The liquid crystal layer 50 is formed between the TFT array substrate 10 and the counter substrate 20 so that it is sealed by a closed-circular sealing material 93. That is, in the transmissive liquid crystal device 100 of this exemplary embodiment, the sealing material 93 is shaped like a closed frame that does not have an injection port through which liquid crystal is injected, is closed in the in-plane regions of the substrates 10 and 20, is not exposed at the outer edges of the substrates 10 and 20, and does not have an opening toward the outer edges of the substrates 10 and 20.

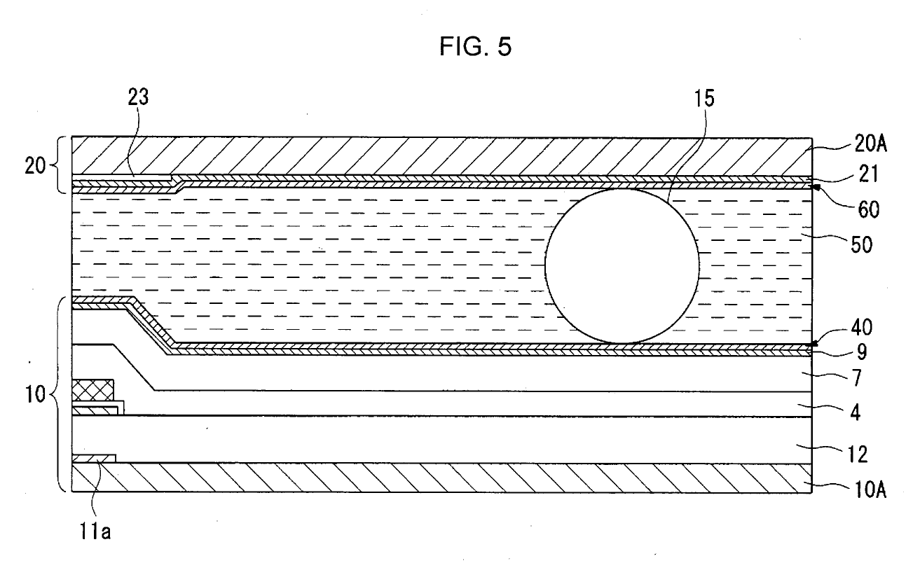

FIG. 5 is a cross-sectional view showing the configuration of a region in which the pixel electrode 9 shown in FIG. 2 is formed, that is, a display region in which the TFT element 30 and the shielding film 23 are not formed. In this region, the liquid crystal layer 50 is also held between the lower TFT array substrate (the TFT elements are not formed in the display region) 10 and the upper counter substrate 20 opposed thereto, in a manner similar to that in the region shown in FIG. 3. In this display region, a predetermined gap is also maintained between the substrates 10 and 20 by spacers 15.

As described above, the spacers 15 are formed between a pair of substrates 10 and 20 that hold the liquid crystal layer 50 therebetween, and the number of the spacers is set at 50 to 150 per square millimeter (e.g., approximately 100 per square millimeter) in the inner area of the sealing material 93. Since the dispersion density of the spacers is low in this embodiment in this way, display quality is rarely reduced by light leakage adjacent to the spacers 15.

In the related art liquid crystal device in which the liquid-crystal injection port is formed in the sealing material, it is not preferable to inject liquid crystal before substrate bonding, because the liquid crystal may come out through the injection port during substrate bonding. Accordingly, when the sealing material has a liquid-crystal injection port, liquid crystal must be injected after substrate bonding. In contrast, in the liquid crystal device of this exemplary embodiment in which the sealing material 93 does not have a liquid-crystal injection port, liquid crystal cannot be injected after substrate bonding because of the absence of the injection port, and the substrates 10 and 20 must be bonded after dropping liquid crystal onto one of the substrates 10 and 20.

In this case, since the substrates can be bonded in a state where the liquid crystal is dropped on one of the substrates and the spacers 15 are dispersed, not only the spacers 15, but also the liquid crystal receive the pressure (bonding pressure) when the substrates are bonded. Consequently, the number of spacers 15 can be made smaller than that in the related art liquid crystal device having the liquid-crystal injection port, that is, the number of spacers 15 can be reduced to approximately 50 to 150 per square millimeter.

In this way, since the sealing material 93 does not have a liquid-crystal injection port in the liquid crystal device of this exemplary embodiment, the liquid crystal performs the function of receiving a part of the bonding pressure, it is possible to stand the bonding pressure even when the number of spacers 15 is reduced, and a uniform cell gap can be ensured. Therefore, in the liquid crystal device of this exemplary embodiment, since the sealing material 93 is shaped like a closed frame in the in-plane regions of the substrates 10 and 20, the density of the spacers 15 inside the sealing material 93 can be reduced to 50 to 150 spacers per square millimeter. As a result, the influence of the spacers 15 on the display is made less than before, and the contrast is rarely reduced by light leakage adjacent to the spacers 15.

In the liquid crystal device of this exemplary embodiment, when the dispersion density of the spacers 15 is lower than 50 spacers per square millimeter, a uniform thickness of the liquid crystal layer 50 (cell gap) sometimes cannot be easily maintained inside the planes of the substrates 10 and 20, and this results in reduction in display quality. When the dispersion density of the spacers 15 exceeds 150 spacers per square millimeter, the degree of cost reduction is decreased, and light leakage is prone to occur. This may reduce the degree of contrast enhancement. Moreover, from the viewpoint of reliability, the low-temperature-bubble incidence of the liquid crystal layer 50 tends to increase. In a case in which the sealing material 93 does not have a liquid-crystal injection port, as in this exemplary embodiment, it is preferable that the dispersion density of the spacers 15 be approximately 80 to 150 spacers per square millimeter.

While this exemplary embodiment is configured with monochromatic display as a prerequisite, a color filter layer may be formed to perform color display. That is, a color filter layer composed of a color layer and a shielding layer (black matrix) may be provided on the inner side of the upper substrate (counter substrate) 20, a protective layer to protect the color filter layer may be formed, and the pixel electrodes 9 may be formed on the protective layer. A display region includes color layers of different colors, for example, red (R), green (G), and blue (B). Therefore, display regions of the colors constitute each pixel, and color display is possible in each pixel. While the liquid crystal device of this exemplary embodiment is of an active matrix type, for example, the configuration of the present invention is also applicable to, for example, a simple-matrix liquid crystal device.

Next, a description is provided of the structure of the spacers 15 used in the liquid crystal device of this exemplary embodiment. Each spacer 15 may be formed of a spherical member made of, for example, silicon dioxide or polystyrene. The diameter of the spacer 15 is set corresponding to the thickness of the liquid crystal layer 50 sealed in the liquid crystal device (cell thickness, that is, cell gap), and, for example, is selected from the range of 2 μm to 10 μm.

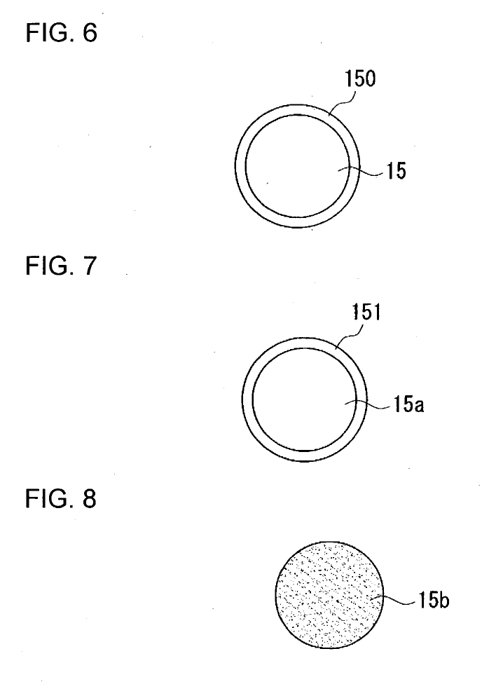

As shown in FIG. 6, the surface of the spacer 15 may be covered with a thermosetting resin layer 150. In this case, when thermosetting resin is cured, the spacer 15 is thereby reliably fixed to the lower substrate (TFT array substrate) 10 and/or the upper substrate (counter substrate) 20. For example, in a production process for the liquid crystal device, the spacers 15 are dispersed on a substrate (for example, a counter substrate 20) different from a substrate on which liquid crystal is dropped (the TFT array substrate 10) and are subjected to heat treatment to cure the thermosetting resin, so that the spacers 15 can be fixed onto the counter substrate 20.

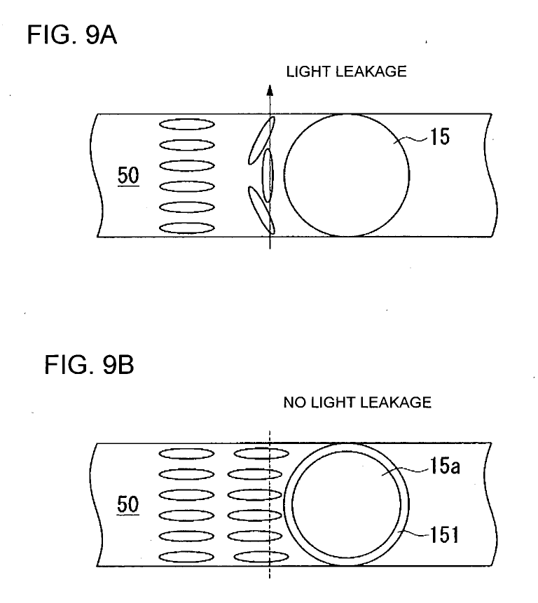

For example, the surface of the spacer 15 may be provided with a surface-treated layer 151 to which a long-chain alkyl group is added, as shown in FIG. 7. A method of providing the surface-treated layer 151 with the long-chain alkyl group is, for example, surface treatment using a silane coupling agent. In a case in which a spacer 15 that is not provided with a surface-treated layer 151 is used, as shown in FIG. 9A, the alignment of liquid crystal molecules is disturbed adjacent to the surface of the spacer 15, and light leakage sometimes occurs in that portion. In contrast, in a case in which a spacer 15a having a surface-treated layer 151 is used, as shown in FIG. 9B, liquid crystal molecules can be aligned in a predetermined direction (vertically aligned in this exemplary embodiment) adjacent to the surface of the spacer 15a, and light leakage rarely occurs in that portion.

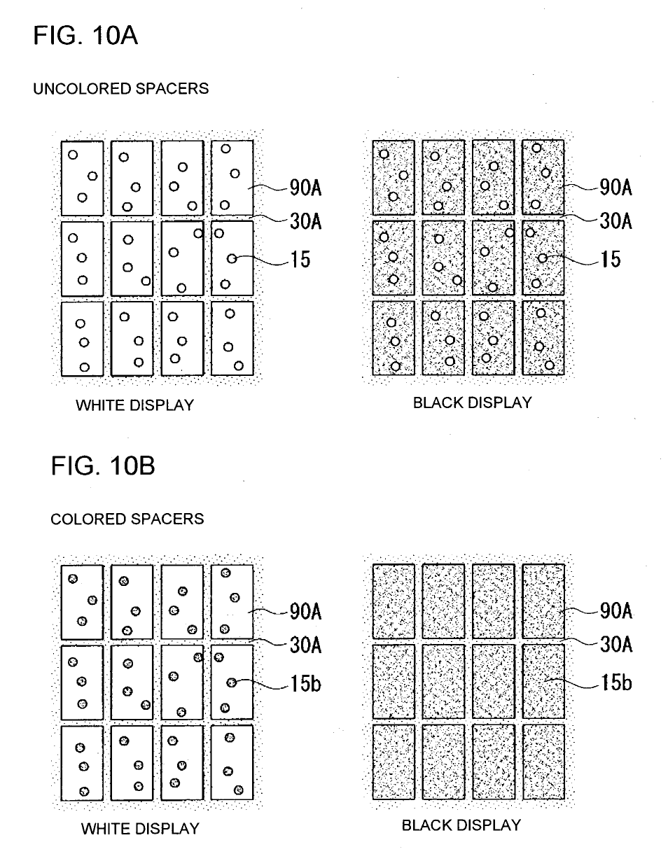

Furthermore, the spacer may be colored. FIG. 8 shows an example of a spacer 15b colored in black. For example, when an uncolored spacer 15 is used, as shown in FIG. 10A, a white dot is displayed corresponding to the spacer during black display (dark display), and this may be one of the causes of contrast reduction. However, by using the color spacer 15b shown in FIG. 8, a white dot corresponding to the spacer is not displayed during black display (dark display), as shown in FIG. 10B. While a black dot corresponding to the spacer is displayed in white display (bright display), the influence of the black dot on the contrast reduction is less than that of the white dot displayed during black display (dark display).

[Production Method for Liquid Crystal Device]

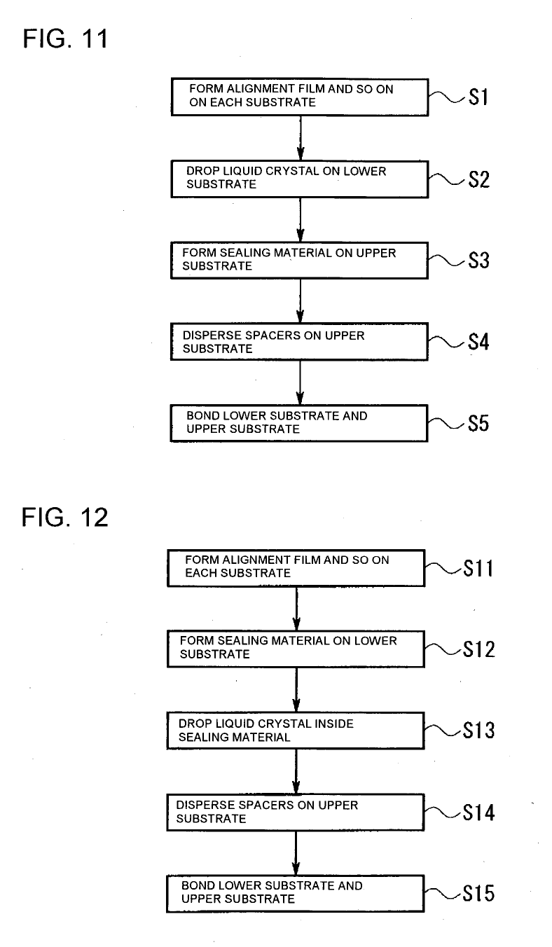

Next, an example of a production method for the liquid crystal device in the above exemplary embodiment is described below with reference to FIGS. 3 and 11. First, in Step S1 in FIG. 11, shielding films 11a, a first interlayer insulating film 12, semiconductor layers 1a, channel regions 1a′, lightly-doped source regions 1b, lightly-doped drain regions 1c, heavily-doped source regions 1d, heavily-doped drain regions 1e, storage-capacitor electrodes 1f, scanning lines 3a, capacitor lines 3b, a second interlayer insulating film 4, data lines 6a, a third interlayer insulating film 7, contact holes 8, pixel electrodes 9, and an alignment film 40 are formed on a lower substrate body 10A made of glass or the like, thereby forming a lower substrate (TFT array substrate) 10. A shielding film 23, a counter electrode 21, and an alignment film 60 are formed on an upper substrate body 20A, thereby forming an upper substrate (counter substrate) 20.

In Step S2 in FIG. 11, a predetermined amount of liquid crystal is dropped on the lower substrate (TFT array substrate) 10. Subsequently, a sealing material 93 is printed on the upper substrate 20 in Step S3 in FIG. 11, and spacers 15 are dispersed on the upper substrate 20 in Step S4. In this case, the sealing material 93 is shaped like a closed frame having no liquid-crystal injection port, as shown in FIG. 4, and the dispersion density of the spacers 15 is set at approximately 50 to 150 spacers per square millimeter inside the sealing material 93.

In Step S5 in FIG. 11, the lower substrate 10 and the upper substrate 20 are bonded together, and optical elements, such as a retardation film and a polarizing plate, that are not shown are outside the lower substrate 10 and the upper substrate 20, so that a liquid crystal device having at least a panel structure shown in FIG. 3 is produced.

As a different production method, the liquid crystal device of the above embodiment may be obtained through the steps shown in FIG. 12. First, in Step S11 in FIG. 12, an alignment film 40 and so on are formed on a lower substrate body 10A made of glass or the like, in a manner similar to that in Step S11 in FIG. 11 described above, thereby forming a lower substrate (TFT array substrate) 10. An alignment film 60 and so on are formed on an upper substrate body 20A to form an upper substrate (counter substrate) 20.

Then, a sealing material 93 having no liquid-crystal injection port and shaped like a closed frame is printed on the lower substrate (TFT array substrate) 10, in a manner similar to above in Step S12 in FIG. 12, and a predetermined amount of liquid crystal is dropped inside the sealing material 93 shaped like a closed frame in Step S13 in FIG. 12. Subsequently, spacers 15 are dispersed on the upper substrate 20 in Step S14 in FIG. 11. In this case, the dispersion density of the spacers 15 is set at approximately 50 to 150 spacers per square millimeter inside the sealing material 93 shaped like a closed frame.

In Step S15 in FIG. 12, the lower substrate 10 and the upper substrate 20 are bonded together, and optical elements, such as a retardation film and a polarizing plate, that are not shown are formed outside the lower substrate 10 and the upper substrate 20, so that a liquid crystal device having at least a panel structure shown in FIG. 3 is produced.

[Electronic Devices]

Specific examples of electronic devices having the liquid crystal device of the above embodiment will now be described.

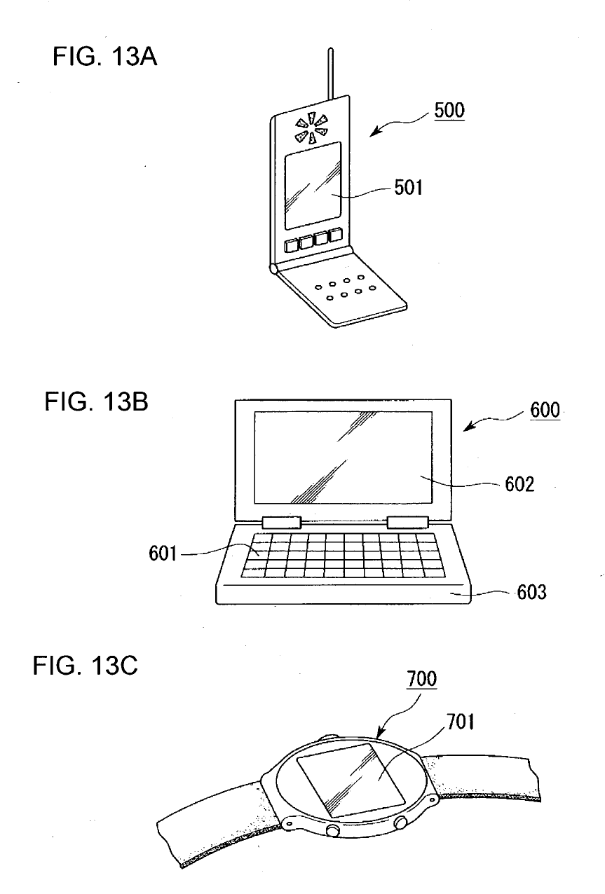

FIG. 13A is a perspective view of an example of a portable telephone. In FIG. 13A, reference numeral 500 denotes a main body of the portable telephone, and reference numeral 501 denotes a liquid crystal display having the liquid crystal device of the above embodiment.

FIG. 13B is a perspective view of an example of a portable information processing device such as a word processor or a personal computer. In FIG. 13B, reference numeral 600 denotes an information processing device, 601 denotes an input section, such as a keyboard, 603 denotes a main body of the information processing device, and 602 denotes a liquid crystal display having the liquid crystal device of the above exemplary embodiment.

FIG. 13C is a perspective view of an example of a watch-type electronic device. In FIG. 13C, reference numeral 700 denotes a main body of the watch, and 701 denotes a liquid crystal display having the liquid crystal device of the above exemplary embodiment.

In this way, since the electronic devices shown in FIGS. 13A to 13C have any of the liquid crystal devices of the above exemplary embodiments, they achieve high display quality.

### EXAMPLES

The following examples were produced in order to certify the characteristics of the liquid crystal device of this exemplary embodiment. As shown in Table 1, liquid crystal devices of Examples 1 to 4 and liquid crystal devices of Comparative Examples 1 to 4 were produced, and the contrast and the uniformity of the cell gap were considered.

First, the liquid crystal devices of Examples 1 to 4 were produced in a production method including the steps shown in FIG. 11, and had the configuration according to the above embodiment. That is, a sealing material 93 did not have a liquid-crystal injection port and were shaped like a closed frame. The dispersion density of spacers 15 was set at 50 spacers, 80 spacers, 110 spacers, and 150 spacers, respectively, per square millimeter from Example 1 in that order, as shown in Table 1.

In contrast, in the liquid crystal devices of Comparative Examples 1 and 2, a sealing material 93 having no liquid-crystal injection port was formed, and the dispersion density of spacers 15 was set at 10 spacers per square millimeter and 200 spacers per square millimeter, respectively. The liquid crystal devices of Comparative Examples 3 and 4 were produced by using a sealing material having a liquid-crystal injection port and injecting liquid crystal from the liquid-crystal injection port after a lower substrate 10 and an upper substrate 20 were bonded together. The dispersion density of spacers 15 was set at 50 spacers per square millimeter and 150 spacers per square millimeter, respectively.

TABLE 1

| | | Spacer | In-plane | | Low- |
|---|---|---|---|---|---|
| | Sealing | Dispersion | Unifor- | | Tem- |
| | Material | Density | mity | Con- | perature |
| | Injection | (pieces/ | of Cell | trast | bubble |
| | Port | mm²) | Gap | Ratio | Incidence |
| Example 1 | Not formed | 50 | B | A | A |
| Example 2 | Not formed | 80 | A | A | A |
| Example 3 | Not formed | 110 | A | A | A |
| Example 4 | Not formed | 150 | A | A | A |
| Comparative | Not formed | 10 | D | C | A |
| Example 1 | | | | | |
| Comparative | Not formed | 200 | A | B | B |
| Example 2 | | | | | |
| Comparative | Formed | 50 | D | C | A |
| Example 3 | | | | | |
| Comparative | Formed | 150 | C | B | A |
| Example 4 | | | | | |

Description of Alphabets
In-plane uniformity of cell gap A: very high B: high C: low D: very low
Contrast ratio A: very high B: high C: low
Low-temperature-bubble incidence A: low-temperature-bubbles are rarely formed B: low-temperature-bubbles may be formed

As shown in Table 1, while the contrast was high and the cell gap was uniform in the planes of the substrates in the liquid crystal devices of Examples 1 to 4, the cell gap in the liquid crystal device of Comparative Example 1 was less uniform than that in the liquid crystal devices of Examples 1 to 4 because the dispersion density of the spacers 15 was 10 spacers per square millimeter. In the liquid crystal device of Comparative Example 2, the contrast was lower than that in the liquid crystal devices of Examples 1 to 4 because the dispersion density of the spacers 15 was 200 spacers per square millimeter. When the dispersion density exceeds 200 spacers per square millimeter, the liquid crystal panel itself becomes hard, and bubbles may be formed inside the liquid crystal layer 50 by expansion and contraction of the liquid crystal due to heat. Furthermore, since the sealing material had the liquid-crystal injection port and liquid crystal was injected after substrate bonding in the liquid crystal devices of Comparative Examples 3 and 4, the cell gap in the planes was less uniform than that in the liquid crystal devices of Examples 1 to 4.

When the substrates were bonded after liquid crystal was dropped on one of the substrates in Comparative Examples 3 and 4, liquid crystal leaked out through the injection port during bonding. As a result, the effect of reception of the bonding pressure by the liquid crystal could not be achieved. In Comparative Examples 3 and 4 in which the dispersion density of the spacers was set at 50 to 150 spacers per square millimeter, the cell gap was not uniform.

[Advantages]

As described above, in the liquid crystal device of the present invention in which spacers are placed between a pair of substrates that hold a liquid crystal layer therebetween, the liquid crystal layer and the spacers are placed inside a sealing material shaped like a closed frame in the planes of the substrates, and the density of the spacers inside the sealing material is set at 50 to 150 spacers per square millimeter. Therefore, when the liquid crystal device is produced, a step of bonding the substrates after liquid crystal is dropped on one of the substrates can be adopted. In this case, since the substrates can be bonded in a state in which the liquid crystal was dropped and the spacers are dispersed on the substrate, not only the spacers, but also the liquid crystal receives the pressure of substrate bonding. This can make the number of spacers smaller than that in the conventional liquid crystal device having an injection port.

More specifically, the number of spacers can be set at approximately 50 to 150 spacers per square millimeter, as described above. As a result, the influence of the spacers on the display is made less than before, and, for example, the contrast is rarely reduced by light leakage adjacent to the spacers. Therefore, the present invention can enhance the display quality and can reduce the cost by reducing the number of spacers to be used.

What is claimed is:

1. A liquid crystal device, comprising:
a pair of substrates;
a liquid crystal layer;
a sealing material; and
spacers placed between the pair of substrates that hold the liquid crystal layer therebetween, the liquid crystal layer and the spacers being placed in an inner region surrounded by the sealing material inside planes of the substrates, the density of the spacers in the inner region surrounded by the sealing material being 50 to 150 spacers per square millimeter.

2. The liquid crystal device according to claim 1, the sealing material being shaped like a frame that is not exposed at outer edges of the substrates.

3. The liquid crystal device according to claim 1, the sealing material being shaped like a closed frame that does not have an opening pointing toward outer edges of the substrates.

4. A production method of the liquid crystal device according to claim 1, the production method comprising:
dropping liquid crystal on one of the substrates;
forming the sealing material shaped like a closed frame on one of the substrates and in the plane of the substrate;
dispersing the spacers on one of the substrates; and
bonding the pair of substrates;
the dispersion density of the spacers being set at 50 to 150 spacers per square millimeter in the inner region of the sealing material.

5. A production method of the liquid crystal device according to claim 1, the production method comprising:
forming a sealing material shaped like a close frame on one of the substrates and in the plane of the substrate;
dropping liquid crystal in the inner region of the sealing material;
dispersing the spacers on one of the substrates; and
bonding the substrates together;
the dispersion density of the spacers being set at 50 to 150 spacers per square millimeter in the inner region of the sealing material.

6. An electronic device, comprising:
the liquid crystal device according to claim 1.
